(19) United States
(12) Patent Application Publication
(10) Pub. No.: US 2005/0286343 A1
(43) Pub. Date: Dec. 29, 2005

(54) Dynamic in-line mixing device

(76) Inventors: Jacques Boutet, St Arnoult (FR); Michel Vullin, Maisons Alfort (FR)

Correspondence Address: STITES & HARBISON PLLC, 1199 NORTH FAIRFAX STREET, SUITE 900, ALEXANDRIA, VA, 22314, US

(21) Appl. No.: 11/152,782

(22) Filed: Jun. 15, 2005

(30) Foreign Application Priority Data
Jun. 18, 2004 (FR) 04 06670

(51) Int. Cl. B01F 7/10

(52) U.S. Cl. 366/303; 366/317

(57) ABSTRACT

Dynamic in-line mixing device for intimately mixing a product formed of at least two primary products, comprising: a casing (2) that is elongate and internally cylindrical of revolution with at least one inlet (3) for the product to be mixed and one outlet (4) for the intimately mixed product; a rotor (5) internal to and coaxial with the casing (2) and means for driving the rotor; the rotor supports a multitude of successive coaxial discs (7), each of which comprises a plurality of holes (8), and the casing supports a multitude of successive coaxial discs (10), each of which comprises a central orifice (11) for the passage of the rotor and a plurality of holes (13); the discs (7) of the rotor (5) and the discs (10) of the casing (2) alternating with one another axially and being separated from one another.

### FIELD OF THE INVENTION

The present invention relates in general to the field of dynamic in-line mixers and, more precisely, relates to improvements made to dynamic in-line mixing devices for intimately mixing a product formed of at least two primary products, comprising:
a casing that is more or less elongate and internally cylindrical of revolution with at least one inlet for the said product to be mixed and at least one outlet for the intimately mixed product,
a rotor internal to the said casing and coaxial therewith, and
means for driving the rotation of the said rotor.

### DESCRIPTION OF THE PRIOR ART

Various types of mixing device are known, having a single rotor or a double rotor (particularly contrarotary rotors) equipped with helical screws, radiating paddles or other devices, which may or may not be associated with fixed reliefs provided on the internal wall of the casing.

These known devices make it possible to mix certain products such as pastes or creams or liquids and in this respect are commonly used in the agrifoodstuffs domain, but they are not able effectively to process other products, such as products with a lumpy tendency, that is to say ones that tend to form lumps, or products obtained from very different respective volumes of primary products and/or of primary products with very different respective viscosities (for example mixing grout with a colorant).

Furthermore, rotors involving a helical screw have the disadvantage of being expensive to manufacture and therefore reserved for applications in which the other types of rotor are unsuitable.

For their part, rotors with vanes have the disadvantage of offering too large a passage cross section (angular sectors between peripherally successive vanes). Furthermore, the vanes, which are often welded onto the central shaft of the rotor, may prove fragile particularly in the case of products of very high viscosity.

It is an object of the invention to overcome the disadvantages of the currently known devices and to propose an improved device which is better able, particularly in terms of its effectiveness and of its cost, to meet the requirements of current practice in certain applications.

### SUMMARY OF THE INVENTION

To this end, the invention proposes a dynamic in-line mixing device as explained in the preamble which, being arranged in accordance with the invention, is characterized in that
the rotor supports a multitude of successive coaxial discs, each disc comprising a plurality of holes, and
the casing supports a multitude of successive coaxial discs, each disc comprising a central orifice for the passage of the rotor and a plurality of holes,
the discs of the rotor and the discs of the casing alternating with one another axially and being separated from one another by successive spacings.

The discs, fixed or rotary, are more or less perpendicular to the axis of rotation of the rotor and bear practically no axial load. The device thus constructed is therefore very robust while at the same time being economical to manufacture, it being possible for the perforated discs to be mass-produced using conventional machining equipment.

What is more, the rotor may be driven by motorizing means, particularly involving an electric motor, which are commonly available and therefore of low cost.

As the rotor rotates, the product is split into a great many paths which constantly change and which pass through the holes in the successive discs and through the spacings between these, and through the functional clearances there are between the external periphery of the rotary discs and the wall of the casing or the internal periphery of the fixed discs and the shaft of the rotor. This multitude of continuously varying paths leads to very intimate mixing of the primary products and to a reduction, or even to the disappearance, of any lumps and gives rise to a product, the composition of which is perfectly homogeneous both in terms of the fineness of its structure and in terms of the quality of the mixing of the primary products.

A mixing device according to the invention has a great many structural parameters and adjusting one or several of these allows it to be tailored to very diverse mixing conditions and/or products.

Thus, provision may advantageously be made for holes to be distributed in a circle near the periphery of at least some discs of the rotor and/or of at least some discs of the casing. However, it is equally possible to contrive for holes to be arranged, particularly distributed in a circle, away from the periphery of at least some discs of the rotor and/or of at least some discs of the casing. These two arrangements may, of course, be combined with one another, the discs concerned then having peripheral and central holes.

It is also possible to contrive for holes in at least some discs of the rotor and/or holes in at least some discs of the casing to be circular in shape so as to process products with a small particle size or liquids, or alternatively to be non-circular (particularly angular such as triangular) in shape so as to process products with a larger particle size or lumpy products. Of course, holes of different shapes may, as need be, be provided on one and the same disc.

Likewise, it may be envisaged for holes in at least some adjacent discs of the rotor and of the casing respectively to be centred on more or less identical respective circumferences, in other words to pass more or less opposite each other; or alternatively to be centred on significantly different respective circumferences if it is desirable for the flow of the streams of product for mixing to be disrupted further.

It is also possible to contrive for the holes in at least some adjacent discs of the rotor and of the casing respectively to be identical in number, particularly over at least one axial portion, or even over the entirety of the length, or on the contrary, for them to be different in number, particularly over at least one axial portion, or even over the entirety of the length. Of course, these two arrangements may be combined on successive portions.

It is also possible to contrive for the spacings between the successive discs belonging alternately to the rotor and to the casing to be equal over at least one axial portion. However, should it prove beneficial, for example in order to take account of possible variations in the viscosity of the product treated between the inlet and the outlet as the product homogenizes, it is possible to envisage the spacings between the successive discs belonging alternately to the rotor and to the casing differing axially, for example it being possible for this variation to occur in successive axial portions; in particular it is possible to contrive for these spacings to vary progressively over at least one axial portion; in particular, it is possible to envisage the spacings becoming shorter near the outlet than near the inlet if the viscosity of the product mixed decreases or being larger if the viscosity of the product mixed increases.

It is also possible to contrive for the holes facing each other in at least some adjacent discs belonging to the rotor and to the casing respectively to have more or less identical cross sections. However, as need be, it is conceivable for the holes in at least some adjacent discs belonging to the rotor and to the casing respectively to have substantially non-identical cross sections; in particular, the cross sections may be substantially smaller near the outlet than near the inlet if the viscosity of the product mixed decreases or may be greater if the viscosity of the product mixed increases.

Finally, the rotational speed of the rotor is of course an important parameter in adjusting the operating conditions of the device in order to obtain the desired result.

In a preferred embodiment of the device of the invention, the casing comprises a single inlet, particularly one arranged coaxially at one of its ends, for letting in a flow formed of the union of at least two primary products, which means that the primary products have been united upstream of the device of the invention, for example using a first T mixer (coarse mixing) situated upstream of the inlet.

However, should it prove necessary and/or technically possible, provision may be made for the casing to comprise at least two inlets for letting in the respective primary products that are to be mixed, and this makes it possible to save on having the first mixer situated upstream, it being possible for all the inlets to be situated parallel to the axis at one end of the casing, or alternatively at least some inlets may be arranged laterally for example in order to carry out staged mixing of several products.

Of course, should it prove useful at least in certain applications, the arrangements set out hereinabove may be combined with one another in order to achieve a desired result. Furthermore, it will be understood that each arrangement can be implemented over the entirety of the length of the rotor, or just over an axial portion of the rotor, it being possible then for successive axial portions to be equipped differently.

### BRIEF DESCRIPTION OF THE DRAWINGS

The invention will be better understood from reading the detailed description which follows of some preferred embodiments which are given solely by way of entirely nonlimiting examples. In this description, reference is made to the attached drawings in which:

FIG. 1 is a very schematic view from above and in diametral section of a device arranged according to the invention;

FIG. 2 is a slightly enlarged and end-on view of the device of FIG. 1, showing the configuration of a disc of the rotor and, viewed partially through the holes therein, of a disc of the casing;

FIGS. 3 to 6 are schematic views showing, under the same conditions as in FIG. 2, various alternative forms of configuration of the discs;

FIGS. 7 and 8 are very schematic views from above and in diametral section of alternative forms of embodiment of the device shown in FIG. 1; and

FIG. 9 is a partially sectioned side view of a concrete example of a complete mixing device according to the invention.

### DETAILED DESCRIPTION OF THE INVENTION

Referring first of all to FIG. 1, a dynamic in-line mixing device according to the invention, denoted in its entirety by the reference 1, de-signed to intimately mix at least two primary products, comprises a casing 2 which is more or less elongate and internally cylindrical of revolution with at least one inlet 3 (here arranged axially at one end of the casing) for the said product that is to be mixed and at least one outlet 4 (here arranged laterally) for discharging the intimately mixed product.

The device 1 also comprises a rotor 5 extending internally to the said casing 2 and coaxially with respect to the latter, and rotational-drive means (not shown in FIG. 1) are provided for driving the rotation (arrow 6) of the rotor 5.

The rotor 5 supports a multitude of successive coaxial discs 7, each disc 7 comprising a plurality of through-holes 8, a clearance 9 remaining between the outer edge of each disc 7 and the wall of the casing 2.

The casing 2 internally supports a multitude of successive coaxial discs 10, each disc 10 comprising a central orifice 11 for the passage of the shaft 12 of the rotor 5 and a plurality of through-holes 13, a clearance remaining between the internal edge of each disc 10 and the shaft 12 of the rotor.

The discs 7 of the rotor 5 and the discs 10 of the casing 2 alternate axially with one another and are separated from one another by respective spacings d. The discs may be kept spaced-apart by spacer pieces and the stacks are held tightly together by appropriate clamping means (clamping rods not shown in respect of the discs belonging to the casing and axial screw and shoulder in the case of the shaft of the rotor).

The rotation of the holes 8 in the discs of the rotor past the fixed holes in the discs of the casing defines, for the product, a multitude of continuously varying flow paths which encourage rigorous stirring-up of the product and leads to effective mixing of the primary products yielding a fine particle size (eliminating the lumps).

The device according to the invention as has just been explained may give rise to a great many alternative forms of embodiment because of the numerous parameters that can be adapted within the structure.

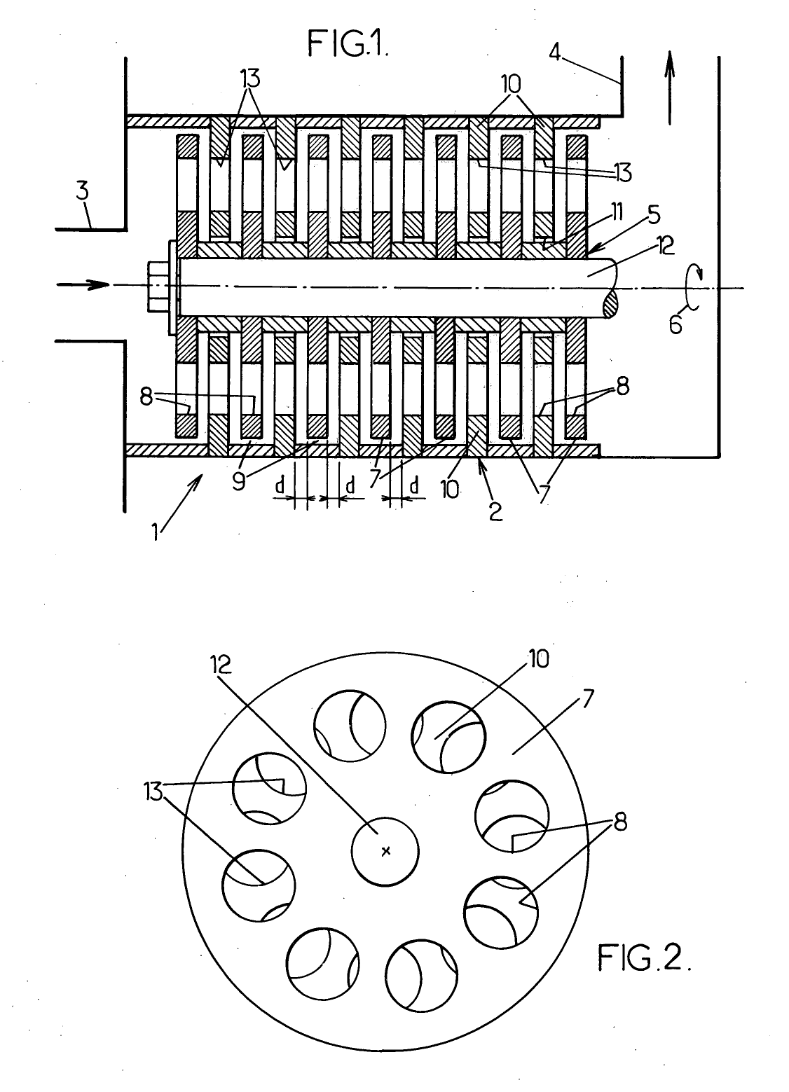

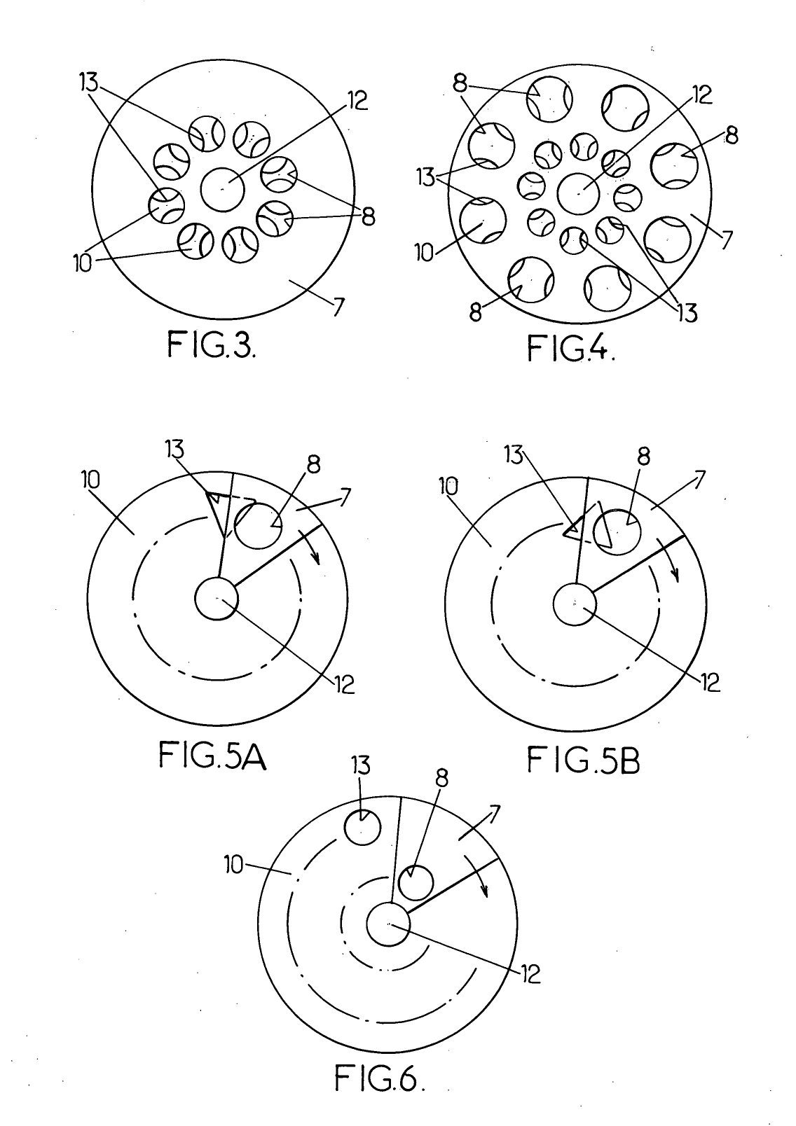

Thus, as illustrated in the example of FIGS. 1 and 2 (the latter showing an end-view of a rotor disc and, through the holes thereof, a casing disc), provision is made for all the holes 8, 13 of all the discs 7, 10 of the rotor 5 and of the casing 2 respectively to be distributed in a circle near the periphery of the discs. However, it is entirely conceivable for holes to be distributed in a circle away from the periphery of the discs, as illustrated in FIG. 3. It is also conceivable for these two arrangements to be combined such that holes are distributed in a circle both at the periphery and towards the centre, as illustrated in FIG. 4.

By way of an alternative, provision may also be made for the holes not to be arranged in a circle, or even for them to be arranged randomly.

Furthermore, the holes 8, 13 illustrated in FIGS. 1 to 5 are circular in shape, but it is perfectly conceivable for them to have other shapes. In particular, polygonal, especially triangular, holes may be envisaged. FIG. 5A illustrates by way of example a fixed disc 10 provided with triangular holes 13 (just one being drawn) with their vertices pointing towards the centre and a rotary disc 7 (just a fragment of this is drawn) provided with round holes 8. FIG. 5B illustrates, by way of another example, a fixed disc 10 provided with triangular holes 13 with their vertices pointing outwards and a rotary disc 7 (just a fragment of this is drawn) provided with round holes 8. In both cases, the round holes and the triangular holes are dimensioned with respect to one another in such a way that, when alignment is achieved, each round hole is inscribed within the triangular hole facing it.

In the examples illustrated in FIGS. 1 to 4 and 6, the holes 8 in the rotor discs 7 and the holes 13 in the discs 10 of the casing 2 are situated on more or less identical circumferences, which means that they sequentially come into coincidence in certain relative angular positions of the discs of the rotor and of the casing. However, such an arrangement is not compulsory and it may be envisaged for the holes of the rotor discs and the holes in the discs of the casing to be situated on different circumferences so that they never coincide, as illustrated in FIG. 6 (only a fragment of a rotary disc 7 being shown) or that they sequentially come into only partial coincidence.

Also, in FIGS. 1 to 6, it has been assumed that the rotor discs and the discs of the casing have the same number of holes. However, it may be envisaged for the holes in the rotor discs to be different in number from the holes in the discs of the casing so that, here again, only partial sequential coincidence between rotor holes and holes in the casing may occur.

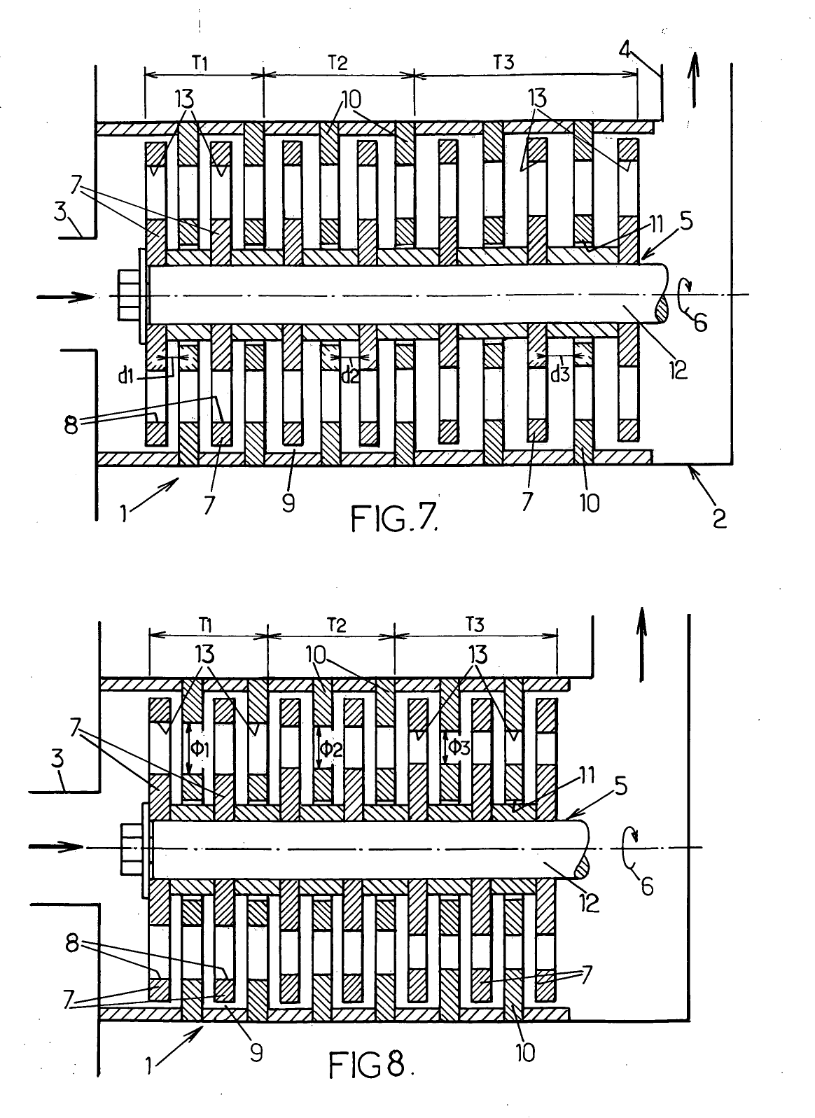

Another important parameter in the operation of the device lies in the spacing between successive discs 7, 10. In the example illustrated in FIG. 1, all the successive discs 7, 10 are distant from one another by equal spacings of magnitude d. However, it is possible to envisage spacings which differ, and for example spacings which are wider at the inlet end and spacings which are shorter at the outlet end, so as to take account of a reduction in the viscosity of the product homogenized by the mixer, or the reverse, as illustrated in FIG. 7, if the intimate mixing of the primary products leads to an increase in the viscosity of the end product. One simple implementation of this device consists, as illustrated in FIG. 7, in arranging the rotor 5 in several successive portions T₁, T₂, T₃ (for example two or three portions) in which the spacings have different magnitudes d₁, d₂, d₃ (for example increasing magnitudes in FIG. 7). Another solution (not depicted) may consist in forming, over the entire length of the rotor or over a part of this length situated towards the outlet, spacings which have successively continuously varying values; in other words, each spacing at position i would have a magnitude dᵢ which would be altered by a quantity ε with respect to the magnitude dᵢ₋₁ of the preceding spacing (in particular which would be reduced or increased by the quantity ε, namely dᵢ=dᵢ₋₁±ε). The quantity ε could itself be a constant quantity or alternatively could be a quantity that varied as a function of the suffix i, or alternatively still could be a percentage of a basic value or of the value of the preceding spacing.

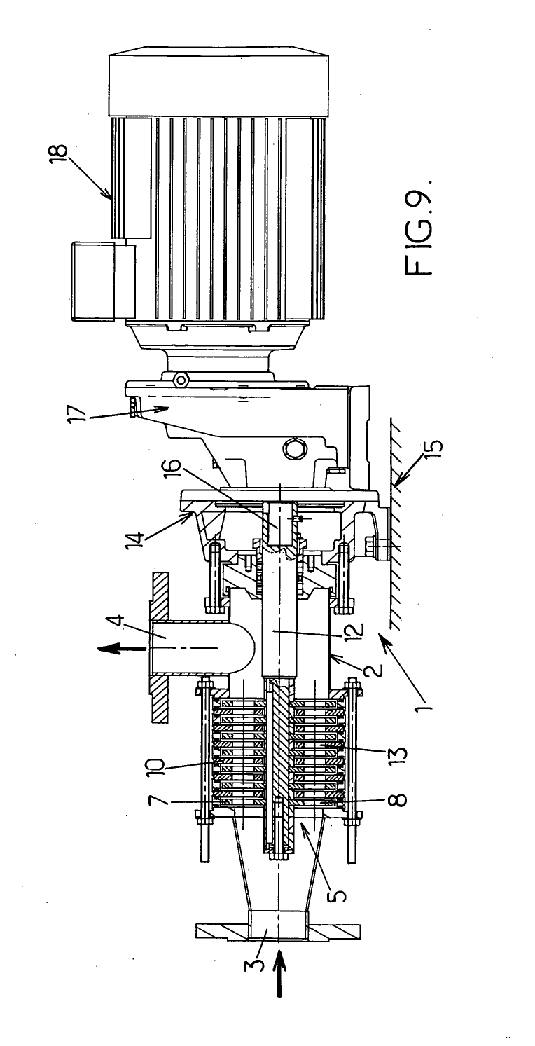

In the examples illustrated in FIGS. 1 to 7, the holes 8, 13 facing each other in adjacent discs 7, 10 belonging respectively to the rotor 5 and to the casing 2 have more or less identical cross sections over at least one axial portion of the rotor; for example, the circular holes 8, 13 illustrated in FIGS. 1 and 2 have more or less the same diameter over the entire length of the rotor. However, this arrangement is not compulsory and it is possible to envisage holes 8, 13 having, respectively, different cross sections on several axial portions as illustrated in FIG. 8 (in this instance this arrangement is associated with identical spacings between the successive discs), or cross sections that vary continuously over at least one axial portion. In FIG. 8, the circular holes 8, 13 have different diameters Ø₁, Ø₂, Ø₃, which in this instance decrease over the respective axial portions T₁, T₂, T₃ of the rotor for a mixture that has a viscosity which decreases (these diameters increasing in the case of a mixture with an increasing viscosity).

Of course, all the conceivable alternative forms of the above devices may be combined with one another, if they are technically compatible. Furthermore, as was suggested hereinabove, all or some of the envisaged alternative variations may be implemented over the entire length of the rotor or over just a portion thereof.

Of course, the rotational speed of the rotor is an important parameter in adjusting the operating conditions of the device which are required for a given application. Altering the clearances between the discs and the casing and the rotor respectively also allows influence to be had over the flow of product through the device.

FIG. 9 illustrates by way of example a mixing device according to the invention shown in its entirety (the same numerical references as in FIGS. 1 and 2 are used again to denote the parts that are the same). The mixer is assumed to be analogous with that in FIG. 1, with the alternation of discs 7, 10 which are separated by equal spacings and provided with circular holes 8, 13 as shown in FIG. 2.

Upstream of the mixing device 1 there is a first mixer (for example a T-mixer), not shown, which receives and coarsely mixes two primary products and, under the action of pumping means, the resulting product that is to be intimately mixed is delivered to the inlet 3 which, in the example illustrated, is an axial inlet situated coaxially with the rotor 5. The casing 2 is secured to a supporting structure 14 which is itself fixed on a mounting base 15. The shaft 12 of the rotor 5 rotates as one with the output shaft 16 of a reduction gearbox 17 fixed to the support structure 14 (or of which the support structure 14 forms an integral part of the casing), the reduction gearbox 17 being itself coupled to the output shaft of an electric driver motor 18. A dynamic in-line mixing device thus arranged calls upon equipment currently commercially available and can be produced at a relatively low cost. Its performance is excellent and it is possible to adapt it very easily to very diverse products by specifically adjusting all or some of the structural parameters, some of which have been discussed hereinabove, and the length of the rotor (and therefore the number of discs, the discs being mounted both on the rotor and in the casing with the interposition of tubular spacer pieces as visible in FIGS. 1, 7 and 8) and the speed at which the rotor 5 rotates.

It will be emphasized that the casing may have a single inlet, for example an axial one as shown in FIG. 9, for simultaneously letting in primary products; however, it is also conceivable to provide several inlets, particularly one inlet or several inlets at one end of the casing and another or several other inlet(s) situated laterally on the casing: it then becomes possible to perform staged mixing of several products; for example two products are introduced, together or separately, at one end of the casing and are mixed over a first portion of the casing, then a third product is introduced laterally and is mixed in with the previous ones over a second portion of the casing, etc.

1. A dynamic in-line mixing device for intimately mixing a product formed of at least two primary products, comprising:
a casing that is more or less elongate and internally cylindrical of revolution with at least one inlet for the said product to be mixed and at least one outlet for the intimately mixed product,
a rotor internal to the said casing and coaxial therewith, and
means for driving the rotation of the said rotor,
wherein the rotor supports a multitude of successive coaxial discs, each disc comprising a plurality of holes (8),
wherein the casing supports a multitude of successive coaxial discs, each disc comprising a central orifice for the passage of the rotor and a plurality of holes, and
wherein the discs of the rotor and the discs of the casing alternate with one another axially and are separated from one another by respective spacings.

2. The device according to claim 1, wherein holes are distributed in a circle near the periphery of at least some discs of the rotor and/or some discs of the casing.

3. The device according to claim 1, wherein holes are distributed in a circle away from the periphery of at least some discs of the rotor and/or some discs of the casing.

4. The device according to claim 1, wherein holes in at least some discs of the rotor and/or holes in at least some discs of the casing are circular in shape.

5. The device according to claim 1, wherein holes in at least some discs of the rotor and/or holes in at least some discs of the casing are non-circular in shape.

6. The device according to claim 1, wherein holes in at least some adjacent discs of the rotor and of the casing respectively are centred on more or less identical respective circumferences.

7. The device according to claim 1, wherein holes in at least some adjacent discs of the rotor and of the casing respectively are centred on significantly different respective circumferences.

8. The device according to claim 1, wherein the holes in at least some adjacent discs of the rotor and of the casing respectively are identical in number.

9. The device according to claim 1, wherein the holes facing each other in at least some adjacent discs of the rotor and of the casing respectively are different in number.

10. The device according to claim 1, wherein the spacings between the successive discs belonging alternately to the rotor and to the casing are equal over at least one axial portion.

11. The device according to claim 1, wherein the spacings between the successive discs belonging alternately to the rotor and to the casing differ over at least two axial portions.

12. The device according to claim 1, wherein the spacings between the successive discs belonging alternately to the rotor and to the casing vary progressively over at least one axial portion.

13. The device according to claim 1, wherein the holes in at least some adjacent discs belonging to the rotor and to the casing respectively have more or less identical cross sections over at least one axial portion.

14. The device according to claim 1, wherein the holes in at least some adjacent discs belonging to the rotor and to the casing respectively have significantly non-identical cross sections.

15. The device according to claim 1, wherein the casing comprises a single inlet for letting in a flow formed of the union of at least two primary products.

16. The device according to claim 1, wherein the casing comprises at least two inlets for letting in the respective primary products that are to be mixed.
